(19) United States
(12) Patent Application Publication
(10) Pub. No.: US 2004/0236478 A1
(43) Pub. Date: Nov. 25, 2004

(54) Vehicle including a sensor for detecting an obstruction in a window opening

(76) Inventors: Yann Le Gallo, Orleans (FR); Mickael Lebourgeois, Auvilliers En Gatinais (FR)

Correspondence Address: CARLSON, GASKEY & OLDS, P.C., 400 WEST MAPLE ROAD, SUITE 350, BIRMINGHAM, MI, 48009, US

(21) Appl. No.: 10/845,998

(22) Filed: May 14, 2004

(30) Foreign Application Priority Data
May 16, 2003 (FR) FR 03 05 890

(51) Int. Cl. G06F 17/00

(52) U.S. Cl. 701/1; 701/49

(57) ABSTRACT

A vehicle includes two power-driven moving openable members, such as windows, on the same side of the vehicle and a single obstruction sensor or detector for both of the openable members. The same obstruction sensor or detector detects an obstruction present on the path of either of the moving openable members, reducing the cost of installing a system that protects against trapping objects or obstructions, such as a hand or fingers.

### REFERENCE TO RELATED APPLICATIONS

This application claims priority to French Patent Application FR 03 05 890 filed on May 16, 2003.

### TECHNICAL FIELD

This invention relates to a motor vehicle including a sensor for detecting an obstruction in an openable member, such as a vehicle window.

### BACKGROUND OF THE INVENTION

Motor vehicles are commonly fitted with electrically driven window regulators. Standards require that the travel of the window be interrupted if an obstruction is present.

Obstruction detection solutions have been proposed. For example, U.S. Pat. No. 5,955,854 discloses an optical anti-pinch system in which each window is fitted with a detection system. A disadvantage of this solution is that it is expensive because multiple detection systems are required.

Therefore, there is a need for a simpler, less expensive obstruction detection system.

### SUMMARY OF THE INVENTION

The present invention provides a vehicle including two moving openable members on one side of the vehicle and a single obstruction detector for both of the two openable members.

In one embodiment, the two openable members move in a common opening. In another embodiment, the two openable members are adjacent along a seal. In yet another embodiment, one of the two openable members is a rear openable member, and the seal is integral with the rear openable member.

In one embodiment, the two openable members are a front openable member and a rear openable member on the same side of the vehicle, and the obstruction detector is in a lower front corner of the front openable member.

According to one embodiment, the two openable members each move in an opening. In another embodiment, one of the two openable members is a rear openable member, and movement of the rear openable member is non-linear.

According to one embodiment, a rear view mirror of the vehicle holds the obstruction detector. In another embodiment, a dashboard of the vehicle holds the detector.

In one embodiment, the two openable members move in their respective openings up to a closing contact line. The obstruction detector includes a light sensor that detects light at the closing contact line and an analysis circuit for analyzing the timing of the light received by the sensor. The analysis circuit compares the distribution of the light received by the light sensor to a reference distribution.

### BRIEF DESCRIPTION OF THE DRAWINGS

Other characteristics and advantages of the invention are given in the following detailed description of the embodiments of the invention, given as an example only and in reference to the sole figure.

FIG. 1 schematically illustrates a view of a surface of a vehicle in which the invention may be implemented.

### DETAILED DESCRIPTION OF PREFERRED EMBODIMENTS

The present invention provides a vehicle including a single obstruction detector for two moving openable members on the same surface of the vehicle. Thus, the obstruction detector detects an obstruction present in the path of either of the two moving openable members, reducing the installation costs of an anti-pinch system.

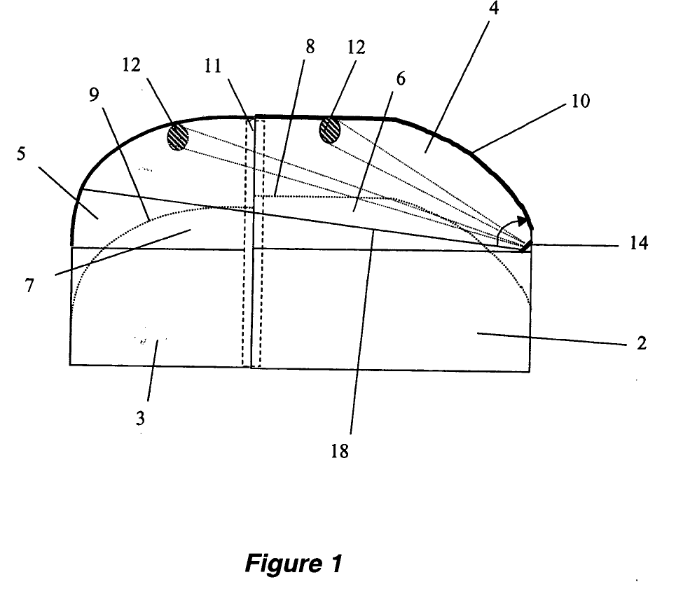

FIG. 1 is a schematic view of a surface of a vehicle in which the present invention may be implemented. The vehicle includes two moving openable members 6 and 7, such as windows, on the same side of the vehicle. The vehicle also includes a single obstruction sensor 14 for both of the two openable members 6 and 7. The surface of the vehicle includes both the side of the vehicle and the roof including the two openable members 6 and 7.

The openable member 6 may be a front openable member in the direction of forward travel of the vehicle, and the openable member 7 may be a rear openable member. FIG. 1 illustrates lower parts 2 and 3 of the vehicle body beneath the two openable members 6 and 7 in the doors of the vehicle, respectively. The two openable members 6 and 7 are, for example, moved by an electric window winder to clear the openings 4 and 5, respectively, and move towards the lower parts 2 and 3 of the body. In FIG. 1, the upper edges 8 and 9, respectively, of the openable members 6 and 7 are illustrated in a position when the two opening member 6 and 7 are completely opened. The movement of the two openable members 6 and 7 may be linear or non-linear. In particular, the movement of the rear openable member 7 may be non-linear, as is the case for convertible vehicles. An upper edge 10 of the openings 4 and 5 is shown as a bold line in FIG. 1. An obstruction 12 is also shown in the vicinity of the upper edge 10.

Thus, a single obstruction sensor 14 is designed to detect the presence of an obstruction 12 for a plurality of openable members and in this case for either of the two openable members 6 and 7. When the obstruction sensor 14 detects an obstruction 12 (such as a hand) as one of the two openable members 6 and 7 is moving upward, operation of the window winder is interrupted or reversed. The obstruction sensor 14 may also be incorporated into an anti-pinch device. The presence of a single obstruction sensor 14 makes the installation of the anti-pinch device less expensive. When at least one of the two openable members 6 and 7 is in a position that clears one of the openings 4 and 5, the obstruction sensor 14 scans the respective opening 4 and 5 to detect the presence of an obstruction 12. If the obstruction sensor 14 detects the presence of an obstruction 12 when the control to close one of the two openable members 6 and 7 has been activated, the movement of the respective openable member 6 and 7 is interrupted, or even reversed, to prevent the pinching of the obstruction 12. The movement of each of the two openable members 6 and 7 and the interruption, or even reversal, of such movement is independent of the other of the two openable members 6 and 7.

The lower parts 2 and 3 of the body may both be lower door parts and may or may not be topped by a window frame. Alternatively, if the vehicle does not include rear passenger doors, the lower part 2 is a front door on a vehicle, and the lower part 3 is an immobile rear lower part.

The two openable members 6 and 7 may move in separate openings 4 and 5. The openings 4 and 5 are, for example, separated by a center pillar between the doors that forms the frame of the body.

Preferably, the two openable members 6 and 7 move in a common opening. In this case, the openings 4 and 5 are not separated by a center pillar. When the two openable members 6 and 7 are in the retracted position in the lower parts 2 and 3, the vehicle includes a single opening that extends along one side of the vehicle. This facilitates the detection of an obstruction 12 by the single obstruction sensor 14 for both of the two openable members 6 and 7. The two openable members 6 and 7 may, for example, also be adjacent along a seal 11. When the two openable members 6 and 7 are raised up to the upper edge 10, the seal 11 ensures the continuity of the seal between the two openable members 6 and 7. The seal 11 ensures the seal between the two openable members 6 and 7 without interfering with the detection of the obstruction 12 by the obstruction sensor 14. Preferably, the seal 11 is integral with the rear openable member 7. This is advantageous when the movement of the rear openable member 7 is non-linear because the seal 11 closes the window channel at the top of the lower part 3 when the rear openable member 7 is retracted or tilted in the lower part 3.

In the example in FIG. 1, the obstruction sensor 14 is arranged in the lower front corner of the opening 4, which corresponds approximately to the fixing point of a rear view mirror. The position and orientation of the obstruction sensor 14 depend on the position and orientation of the front door. The obstruction sensor 14 is positioned in the plane of the two openable members 6 and 7 to facilitate adjustment of the obstruction sensor 14 to detect an obstruction 12 in the opening 4 and 5. The obstruction sensor 14 can also be arranged in the lower rear corner of the opening 5; this is particularly advantageous when the vehicle is a two or three door vehicle because the lower part 3 is immobile, making detection by the obstruction sensor 14 independent of the movement of the front door. Alternatively, the obstruction sensor 14 may be held by the vehicle's rear view mirror. Thus, the obstruction sensor 14 is offset towards the outside of the vehicle, reducing the blind spots in which the obstruction sensor 14 is unable to detect the presence of an obstruction 12 due to the presence of the center pillar, for example. The obstruction sensor 14 can also be held by the vehicle's dashboard. This is advantageous because detection by the obstruction sensor 14 is independent of the movement of the lower parts 2 and 3 when the lower parts 2 and 3 are doors.

If the obstruction sensor 14 is held by the lower part 2, which is one of the front doors of the vehicle, it may be advantageous for the closing movement of the rear openable member 7 to be disabled when the front door is opened. When the front door is open, the field of vision of the obstruction sensor 14 is diverted and no longer covers the rear openable member 7 or the opening 5 cleared by the rear openable member 7. The detection of the presence of an obstruction 12 across the opening 5 is therefore not possible, and thus it is preferable to disable the movement of the rear openable member 7 when the front door is open.

The obstruction sensor 14 may be optical. The obstruction sensor 14 may include a light sensor covering the closing contact lines of the two openable members 6 and 7 and an analysis circuit for the timing analysis of the light received by the obstruction sensor 14. The analysis circuit is designed to compare the distribution of the light received by the obstruction sensor 14 to a reference distribution. The variation in the light distribution represents the presence of an obstruction 12.

Such sensors are known for detecting obstructions. Other sensors for analyzing optical or other information would, of course, come within the scope of this invention. The obstruction sensor 14 monitors an approximately vertical angular area or angular sector 18. The angular sector 18 covers the part of the opening 4 delimited by the upper edge 10 and a half line extending from the obstruction sensor 14. In other words, the optical obstruction sensor 14 covers an area adjacent to the upper edge in the plane of the openings 4 and 5 or in the plane of the two openable members 6 and 7 as this is the area in which the pinching must be detected. It is not necessary to detect the presence of an obstruction 12 near the lower edge of the openings 4 and 5.

Of course, this invention is not limited to the embodiments described as an example. Obstruction detection applies not only to windows, as explained above, but also to other types of moving openable members, such as motor-driven sunroofs, for example.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

What is claimed is:

1. A system for detecting an obstruction in an opening of a vehicle comprising:
two moving openable members on a common side of the vehicle; and
a single obstruction detector corresponding to the two moving openable members.

2. The system according to claim 1, wherein the opening comprises a common opening, and wherein the two moving openable members move in the common opening.

3. The system according to claim 1, wherein the two moving openable members comprise a front openable member and a rear openable member, and wherein the system further comprises a seal that is adjacent to both the front operable member and the rear openable member.

4. The system according to claim 3, wherein the seal is integral with the rear openable member.

5. The system according to claim 1, wherein the two moving openable members comprise a front openable member and a rear openable member and the opening comprises a front opening and a rear opening, and the front openable member is moveable in the front opening and the rear openable member is moveable in the rear opening, and wherein the single obstruction detector is located in a front lower corner of the front opening.

6. The system according to claim 1, wherein the two moving openable members are each moveable in the opening.

7. The system according to claim 1, wherein the two moving openable members comprise a front openable member and a rear openable member, and wherein the rear openable member moves non-linearly.

8. The system according to claim 1, further comprising a rear view mirror that holds the single obstruction detector.

9. The system according to claim 1, further comprising a dashboard that holds the single obstruction detector.

10. The system according to claim 1, wherein the two moving openable members are moveable in the opening, and the two moving openable members contact a closing contact line when in a closed position, the single obstruction detector comprising:
a light sensor that detects a distribution of light at the closing contact line; and
an analysis circuit to analyze timing of the distribution of light received by the light sensor, wherein the analysis circuit compares the distribution of the light received by the light sensor to a reference distribution.

11. A method for detecting an obstruction in an opening of a vehicle comprising the steps of:
moving two openable members on a common side of the vehicle; and
detecting an obstruction with a single obstruction detector corresponding to the two openable members.

12. The method according to claim 11, wherein the two openable members comprise a front openable member and a rear openable member and the opening comprises a front opening and a rear opening, and the front openable member is moveable in the front opening and the rear openable member is moveable in the rear opening, and wherein the single obstruction detector is located in a front lower corner of the front opening.

13. The method according to claim 11, wherein the step of detecting the obstruction further comprises:
detecting a distribution of light at a closing contact line of the opening, wherein the two openable members contact the closing contact line when in a closed position; and
comparing a timing of the distribution of light to a reference distribution.
